(19) United States
(12) Patent Application Publication
(10) Pub. No.: US 2007/0257512 A1
(43) Pub. Date: Nov. 8, 2007

(54) Fuel efficient dynamic air dam system

(76) Inventor: Scott Anderson, Douglas, MA (US)

Correspondence Address: LAW OFFICE OF JILL SHEDD & ASSOCIATIONS, P.C., 430 FRANKLIN VILLAGE DR, #212, FRANKLIN, MA, 02038, US

(21) Appl. No.: 11/429,741

(22) Filed: May 8, 2006

(51) Int. Cl. B62D 35/00

(52) U.S. Cl. 296/180.1

(57) ABSTRACT

Active, aerodynamic controller that describes a method for dynamically controlling airflow using computer controlled movable air dams and airfoils on motor vehicles. It is well known that motor vehicles generally have a great deal of aerodynamic friction also known as drag. Fuel efficiency is greatly affected by a vehicle's aerodynamic drag. Aerodynamic drag is caused by both induced drag and parasitic drag. Parasite drag is somewhat fixed by the overall design and shape of a vehicle. Parasite drag is caused primarily by the laminar flow of air over the smooth surfaces of the vehicle's hood, roof, windows, side mirrors and door panels. Induced drag is much more variable and is primarily created by the differential pressure effects of air flowing over, under and around a vehicle, as well as the relative airflow caused by both ground effect and atmospheric air density and wind. This invention serves to actively minimize the effects of induced drag thus reducing the amount of fuel used by vehicles fitted with this invention.

### BACKGROUND OF THE INVENTION

1. Technical Field

The present invention generally relates to motor vehicles and aerodynamic drag. More particularly, the present invention relates to a microcomputer controlled aerodynamic management system for motor vehicles that controls a plurality of movable aerodynamic surfaces (sometimes referred to as air dams and foils). The present invention also addresses the direct and active management of induced air drag as it relates to varying speeds and environmental conditions, such as road and wind conditions, encountered by motor vehicles during travel.

2. Description

The fuel economy of a motor vehicle is significantly affected by induced drag. Induced drag is created primarily by the difference in air pressure between the top and bottom of a vehicle. As a result, vehicle fuel efficiencies are directly affected by vehicle speed, air densities, ground features, wind and wind direction.

Many of today's vehicle designs improve aerodynamic efficiency by reducing induced drag through specialized body shapes and improved streamlined designs. Streamlining of a vehicle gives rise to increased parasite drag caused by laminar airflow over these smoother surfaces. Other methods for improving aerodynamics of vehicles are achieved through the use of frontal air dams, engine compartment spoilers, rear deck lid air foils and side skirts. All of these help to reduce induced drag but also add increased parasitic surface drag. These solutions also do not address the changing conditions that occur when a vehicle encounters wind and wind gusts from varying angles and varying road surface conditions. Because of the large difference in the cord surface area of the top and bottom of a motor vehicle, these efforts all fall far short of achieving an ideal induced drag coefficient without also significantly increasing the amount of surface born parasitic drag.

While these solutions have improved fuel economies and increased vehicle handling they still are far away from an ideal solution. For example, static air dams only improve air flow at specific relative air speeds which do not take into account other variables such as wind and wind direction or temperature and air density. All those factors, such as wind and wind direction, temperature and air density have a great effect on the overall aerodynamic character of a vehicle. Rarely are wind speed conditions or angle relative to the vehicle predictable. Also, seldom do frontal air dams extend close enough to the road surface to be fully effective. Fixed air dams also present a potential for catching on and impacting debris lying on the road or on raised parking curbs.

Therefore it is desirable to improve a motor vehicle's aerodynamics and improve upon the limitations of current solutions for improving vehicle induced drag characteristics by applying real-time active aerodynamically controlled surfaces. The aerodynamic surfaces in the present invention will work in concert by varying its aerodynamic angles and shapes according to direct monitoring of the actual vehicle's environment during travel. Through the use of a software programmable microprocessor based controller and a plurality of sensor input devices a method for dynamically controlling the aerodynamic surfaces of a motor vehicle can be described. Through this method, motor vehicles can be made to have better stability and reduced overall induced drag while not significantly increasing static parasitic drag. This provides a way to greatly improved fuel efficiencies under varying road, wind and temperature conditions.

### SUMMARY OF INVENTION

It is the objective of the present invention to create a system that actively, dynamically, and in real-time adjusts the aerodynamics of a motor vehicle thus improving vehicle fuel efficiency while maintaining safe handling characteristics over a wide range of vehicle speeds, wind speeds, wind direction, and road surface conditions.

In one form, the present invention provides a system for controlling the aerodynamics of a vehicle comprising of a programmable microprocessor controller containing real-time software algorithms (Aerodynamic Control Unit), pressure, temperature, proximity sensors, micro switches, servo motor amplifiers, and linear servo encoder motors (positioning servos) attached to one or more movable aerodynamic surfaces such as a variable active front air dam, variable active rear deck lid mounted air foil and variable active side mounted body skirts.

The Aerodynamic Control Unit provides active computational output control of positioning servos through algorithmic responses to input signals from various sensors, micro switches and vehicle speed detection circuits. The Aerodynamic Control Unit is used to execute a plurality of software algorithms which collectively determine the best position for each of the active aerodynamic surfaces of the vehicle through the direct control of the attached positioning servos.

The pressure and temperature sensors are used to provide analog signals to the Aerodynamic Control Unit used by the software algorithms for measuring temperature and pressure and are placed at a plurality of locations on the vehicle. The pressure sensors combined with the current vehicle speed input provides a means for the Aerodynamic Control Unit software algorithms to determine how the air is flowing over under and around the vehicle and how it is affecting the vehicle's induced drag at any given speed. With this information the software algorithms can continuously adjust the positioning servos of active variable aerodynamic surfaces of the vehicle to achieve the best possible drag coefficient.

The proximity transducers are mounted along the fascia of the front air dam pointing down at a specific angle in the forward direction. These transducers provide a means for the Aerodynamic Control Unit and software to detect both road surface height as well as any approaching road debris. Using the input from the proximity transducers the Aerodynamic Control Unit and software algorithms maintain both an optimal air dam height over the road as well as detecting approaching road debris. By continuously adjusting the positioning servos of the active air dam the best possible drag coefficient is achieved. The Aerodynamic Control Unit will also retract the front air dam as needed when approaching road irregularities or debris. The Aerodynamic Control Unit software would also fully retract the front air dam at low vehicle speeds to prevent impact with objects such as raised parking curbs and road shoulders.

The micro switches are used to detect minimum and maximum deployment of each active aerodynamic vehicle surface. These micro switches provide a means for the Aerodynamic Control Unit and software algorithms to determine the minimum and maximum range of motion for each active aerodynamic surface and to set safety limits for each.

The servo motor amplifiers accept digital input signals from the Aerodynamic Control Unit software algorithms and in turn provide the analog output positioning signals used to control each of the positioning servos attached to the active aerodynamic vehicle surfaces. Position feedback is provided by encoders mounted to the position servos. Signals from the position servo encoders are used by circuits in the servo amplifiers to allow the amplifier to maintain constant control and accuracy over the position and velocity of movement for each active aerodynamic vehicle surface. This arrangement allows for a very fast positioning response to signals from the Aerodynamic Control Unit and software algorithms.

There are three primary aerodynamic surfaces which affect the aerodynamic characteristics of a motor vehicle. A front air dam is used to enhance aerodynamics and stability by varying the blocking of turbulent air flow under the vehicle chassis, side skirts are used to vary the blocking of turbulent air flow from the sides of the vehicle from entering under the vehicle chassis, and rear airfoils are used to help balance the pressure drag caused by differences between the top and bottom surface areas of the vehicle. Collectively these aerodynamic surfaces affect the overall drag caused by both induced and parasitic drag. By dynamically adjusting and varying these aerodynamic surfaces in direct response to actual air pressures, temperatures, and air densities, the air flow around, under and over a vehicle can be finely optimized at any given vehicle speed, wind speed or wind direction to minimize both induced and dynamic drag and to achieve the best possible overall drag coefficient.

An active variable front air dam assembly includes a main mechanical structure and movable air dam operatively mounted below the vehicle's front carriage and attached or integrated with the front bumper or fascia of the vehicle. The movable air dam is downwardly translatable from a fully retracted position to an infinite range of deployed positions up to a maximum depth and or angle as determined by the attached positioning servo.

An active variable rear deck lid mounted adjustable air foil includes a mechanical support structure and a movable airfoil. The movable rear airfoil can be positioned at a range of various relative angles determined by the attached positioning servo.

Active variable side mounted body skirts include a mechanical structure and movable panels mounted under and along the sides of the vehicle carriage. The movable panels are downwardly translatable from a fully retracted position to an infinite range of deployed positions up to a maximum depth and or angle as determined by the attached positioning servos.

Other and further important active aerodynamic surfaces may be considered as these objects and advantages will become apparent from the disclosures in the following specification and accompanying drawings.

### PRIOR ART

There are no devices, inventions or methods that are dynamically and automatically employed from the underside of a vehicle in order to improve fuel efficiency. The closet references to this present invention are as follows:

U.S. Pat. No. 6,209,947 issued to inventor Rundels, et al discloses an adjustable aerodynamic system. This invention does not adjust the aerodynamic surfaces automatically based on environmental conditions, nor does it allow for a variable deployment.

U.S. Pat. No. 4,976,489 by Inventor Lovelace discloses an automatic air darn that deploys based on air velocity. There is a distinction between this invention and the present invention. Inventor Lovelace uses an electronic control or motor to control the deployment of the air dam, and uses the speed of the vehicle, rather than the air velocity. The present invention uses a full system that takes into consideration a myriad of environmental factors and dynamically and in “real time” adjusts the aerodynamic surfaces to best increase fuel efficiency.

### BRIEF DESCRIPTION OF THE DRAWINGS

FIG. 1 is a summary drawing of an exemplary automobile schematic depicting the general placement of several active air surfaces such as an air dam, air spoiler and side mounted skirts. The schematic also depicts an active Aerodynamic Control Unit, linear servo motor drive units and several aerodynamic input sensors described in the preferred embodiment.

FIG. 2 is a high level flow chart depicting the active aerodynamic controller software operations and the relationships and phase of operation relative to the preferred embodiment of the present invention.

FIG. 3 is a block diagram of the key electrical and mechanical components of the preferred embodiment including relationships and flow of information between key components.

### DETAILED DESCRIPTION OF THE PREFERRED EMBODIMENT

The terminology used herein should be interpreted in its broadest reasonable manner, even though it is being utilized in conjunction with a detailed description of a certain specific preferred embodiment of the present invention. This is further emphasized below with respect to some particular terms used herein. Any terminology that the reader should interpret in any restricted manner will be overtly and specifically defined as such in this specification. The preferred embodiment of the present invention will now be described with reference to the accompanying drawings, wherein like reference characters designate like or similar parts throughout.

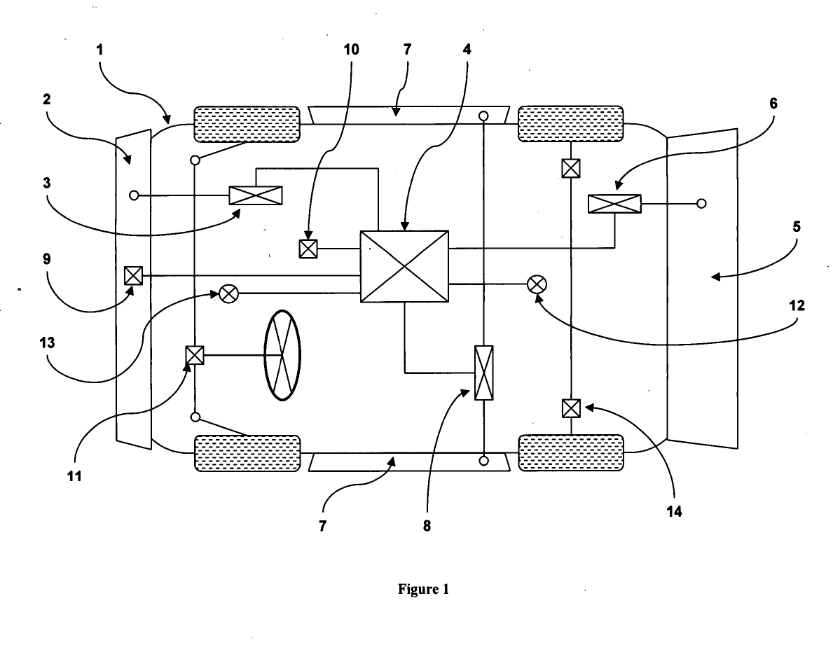

With initial reference to FIG. 1, an active microprocessor controlled aerodynamic system constructed in accordance with the teachings of the preferred embodiment of the present invention is generally identified with reference to the main Aerodynamic Control Unit identified with numeral 4. The Aerodynamic Control Unit 4 is shown operatively associated with an exemplary schematic of a motor vehicle 1. It will become apparent to those skilled in the art after reading the following detailed description that the teachings of the present invention are not limited to the exemplary embodiment.

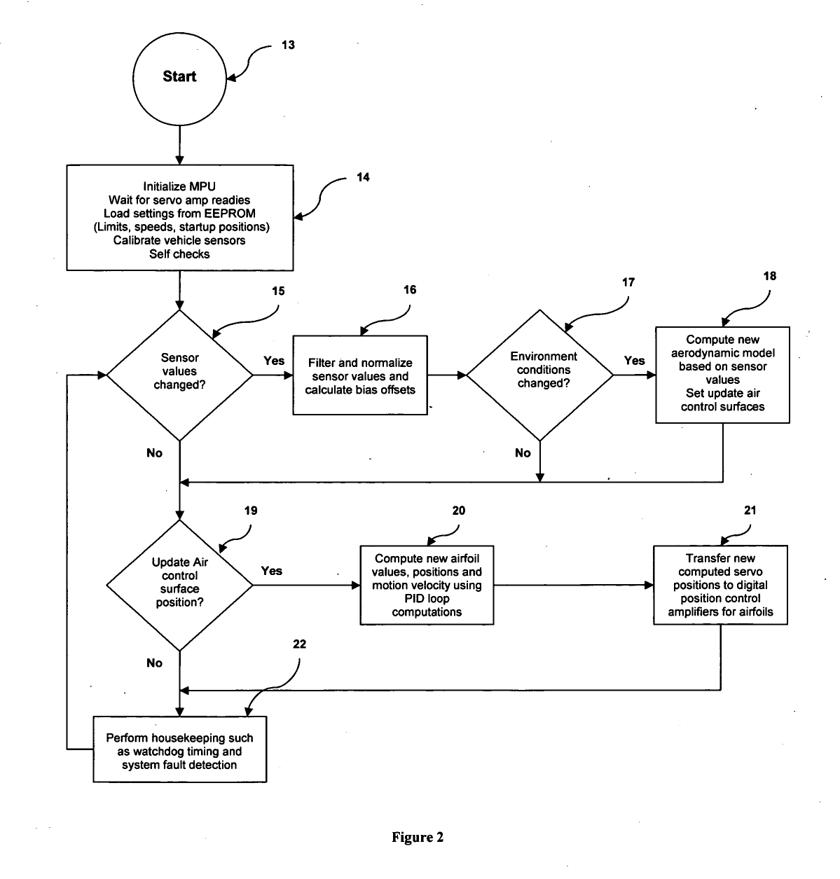

The Aerodynamic Control Unit 4 as shown in FIG. 1 and further described in FIGS. 2 & 3 is the core component of the teachings of the present invention. The preferred embodiment includes a number of associated sensor devices wired to the active Aerodynamic Control Unit 4 to provide numerous vehicle environment and performance information. The preferred embodiment also references a number of adjustable aerodynamic and mechanical controlled air surfaces such as air dams 2, airfoil spoilers 5 and side mounted body skirts 7 used to control the aerodynamic characteristics of a motor vehicle. While these are important to the present invention, they are not directly specific to the present invention and are considered well known in the art. As shown in FIG. 1 the present invention specifically describes a method for actively controlling a front air dam assembly 2, a rear airfoil or spoiler 5, and side body skirts or rocker extensions 7. All components of the preferred embodiment of the present invention will be described in more detail below.

I. Aerodynamic Control Unit

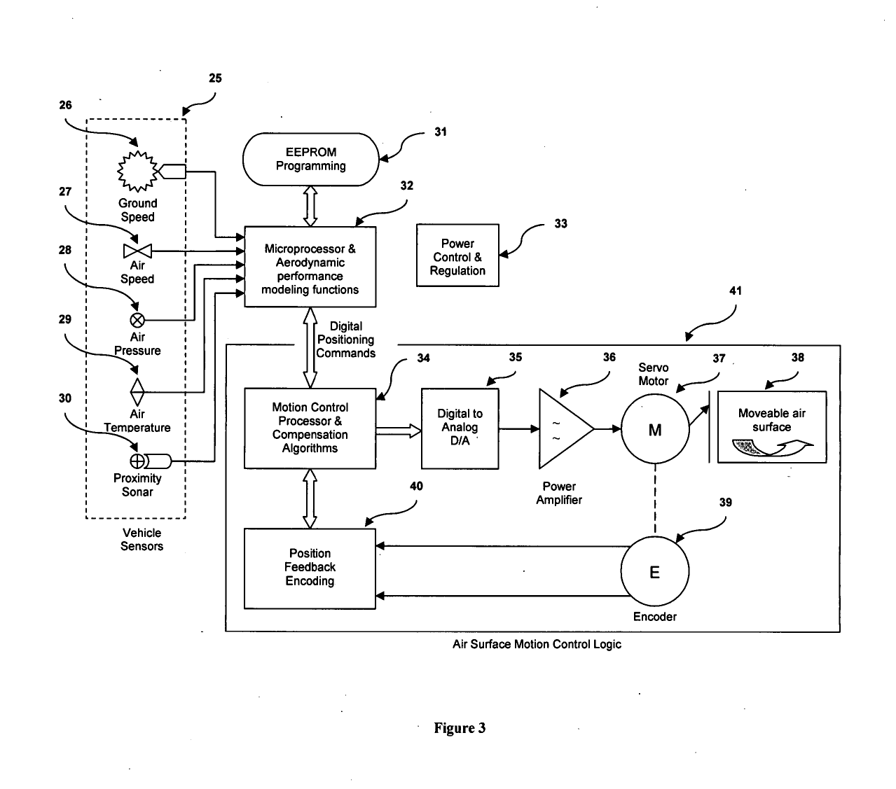

With continued reference to FIG. 1 and additional reference to FIG. 3. The Aerodynamic Control Unit 4 is described as comprising of a number of common integrated circuits including a programmable central processing unit or microprocessor 32, a number of digital closed-loop servo controller circuits 41, and a plurality of integrated analog to digital signal conversion circuits called aerodynamic input sensors 25 in the present embodiment.

The microprocessor 32 is comprised of both analog and digital input circuits and is described as a fully programmable device containing a plurality of general purposes digital and analog input and output circuits, a programmable memory, an arithmetic logic unit, general purpose registers, intergraded timers and clock circuits all used to construct common embedded control automation applications such as the Aerodynamic Control Unit 4 described in this invention and preferred embodiment.

The microprocessor 32 is programmed with highly specialized aerodynamic mathematical formulas and combined with closed-loop digital servo controller circuits 41, a plurality of aerodynamic input sensors 25 and is powered by the vehicle's electrical power system 33. With microprocessor 32 performing thousands of software computations per second and through continuous computations based on vehicle speed and a plurality aerodynamic sensor inputs 25 and by continuously maintaining and positioning servo controlled movable air surfaces on the vehicle 2, 7, 5, the aerodynamics are constantly optimized to achieve the best possible drag coefficient for the current vehicle wind, speed, temperature, and road conditions. With continued reference to FIG. 3 the microprocessor 32 is connected to a non-volatile memory EEPROM 31 where the embedded software application and complex aerodynamic math functions are stored. The microprocessor 32 is also connected to a plurality of aerodynamic input sensors including; a ground speed sensor 26, an air speed sensor 27, an air pressure sensor 28, an air temperature sensor 29, and a proximity sensor 30, collectively called the aerodynamic input sensors 25. The microprocessor is also connected to the motion control processor 34 which performs all computations relating to the compensation algorithms used in the motion control of the vehicle's movable aerodynamic surfaces 2, 5, 7.

With continued reference to FIG. 3, the motion control processor 34 is provided and used to perform all motion control compensation and close-loop feedback functions of the movable aerodynamic surface servo motors. The motion control processor 34 accepts digital commands from the microprocessor 32 which are then interpreted and used to change the positions for each servo controlled vehicle air surface. This motion control processor 34 performs all calculation needed for the precise control, speed and positioning of the vehicle's air control surfaces and is further described later in the section entitled Servo Controlled Air Surfaces.

II. Vehicle Performance and Environment Input System

With continued reference to FIG. 1 and additional reference to FIG. 3, the vehicle performance and attached sensor input circuits will be described. The present invention describes several types of vehicle performance and aerodynamic input sensors 25 used to allow the Aerodynamic Control Unit's microprocessor 32 to compute proper aerodynamic responses to the vehicle's environment. The present invention uses a number of different input circuits and sensors for accurately determining the vehicle's best aerodynamic control surface 2, 5, 7 positions to continuously achieve the most optimal aerodynamic drag coefficient.

a. Proximity Sensor

An electronic proximity sensor 30 is used to detect approaching objects and/or extreme road irregularities. Analog input signals from the proximity sensor 30 are used by the Aerodynamic Control Unit's microprocessor 32 to specifically control the front movable aerodynamic surface (air dam) 2. In the exemplary embodiment illustrated, the proximity sensor 30 is generally mounted in the front of the vehicle 9 embedded in the front fascia or bumper assembly and is wired to the Aerodynamic Control Unit's 4 main microprocessor 32 via an analog input circuit. The analog input value is converted to a digital value by the microprocessor 32 and used to properly calculate the current vehicle's ground clearance and/or detect approaching objects which would require rapid adjustment of the vehicle's front air dam or spoiler to avoid collisions with possible road debris.

b. Temperature Sensor

In this invention and preferred embodiment an electronic analog temperature sensor 29 is used to translate the vehicle's environmental temperature to a digital value used by the Aerodynamic Control Unit's 4 mathematical computations. In the exemplary embodiment illustrated, the temperature sensor 29 is generally mounted in the front of the vehicle 13 behind the front fascia or bumper assembly and is wired to the Aerodynamic Control Units 4 main microprocessor 32 analog temperature input circuit. The analog input value is converted to a digital value by the microprocessor 32 and used in the aerodynamic math functions to properly calculate the current vehicle's drag coefficient.

c. Vehicle Ground Speed Sensor

In this invention and preferred embodiment the vehicle's ground speed sensor 26 is used to provide a digital input value to the Aerodynamic Control Unit's 4 main microprocessor 32. In the exemplary embodiment illustrated, the vehicle's ground speed is derived by a sensor which measures the number of wheel rotations per second as indicated by commonly used magnetic indexing methods. The magnetic indexing method provides a digital pulse train signal to the Aerodynamic Control Unit's 4 microprocessor 32 which is used to accurately determine the current speed of the vehicle for use in the aerodynamic math functions used to calculate the current vehicle's drag coefficient.

d. Vehicle Air Speed Sensor

In this invention and preferred embodiment the vehicle's relative air speed sensor 27 is used to provide an analog input value to the Aerodynamic Control Unit's main microprocessor 32. In the exemplary embodiment illustrated, the vehicle's air speed is derived from an electronic static pitot tube device commonly used in aviation for measuring forward air speeds. The electronic static pitot tube provides an analog signal to the Aerodynamic Control Unit's 4 microprocessor 32 which is converted to a digital value and is used to determine the current vehicle's relative air speed used in the aerodynamic math functions to accurately calculate the current vehicle's drag coefficient.

e. Air Pressure Sensors

In this invention and preferred embodiment the vehicle's undercarriage and surface air pressure sensors 28 are used to provide analog input values to the Aerodynamic Control Unit's 4 main microprocessor 32. In the exemplary embodiment illustrated, the vehicle's air pressure sensors 28 are placed between the vehicle's undercarriage 10, and roof and trunk surfaces 12 and are used for measuring air pressure differences. The pressure sensors provide analog signals to the Aerodynamic Control Unit's 4 microprocessor 32 which are converted to digital values and are used to determine the current vehicle's total induced drag as a result of laminar air flow under and over the vehicle at any given speed. The differential air pressure values are used in the aerodynamic math functions to accurately calculate the current vehicle's drag coefficient.

III. Aerodynamic Control Algorithms

With reference to FIG. 2 and additional reference to FIG. 3, the aerodynamic control algorithms will be described. In this invention and preferred embodiment the active Aerodynamic Control Unit uses a microprocessor 32 and executes embedded software algorithms stored in a non-volatile memory EEPROM 31, which provides the methods for performing complex math functions used to model the aerodynamic performance of the vehicle while in operation.

With continued reference to FIG. 3 and additional reference to FIG. 2, a high level overview of the software operations within the microprocessor 32 will be described in accordance with the teachings of the preferred embodiment of the present invention. When the microprocessor 32 is provided power from the vehicle's power circuits 33 the microprocessor 32 begins by loading the embedded application and math functions from the EEPROM program memory 31 into the microprocessor's 32 execution memory located within the microprocessor 32. After the application and math functions are loaded into the microprocessor's 32 execution memories, it begins to execute these software instructions according to the programming depicted in FIG. 2.

When the microprocessor 32 begins execution 15 of the embedded software applications and math functions loaded from the EEPROM memory 31, it will first perform several setup and initialization functions followed by waiting for commands from the closed-loop digital servo controller circuits 41 to indicate that they are in the ready state for accepting position commands 23. Additional processing includes loading limit, speed and air control surface starting positions values in “Initialize MPU” block 16.

With continued reference to FIG. 2, following the microprocessor program initialization in “Initialize MPU” block 16, sensor value monitoring in “Sensor values changed” block 17, air surface position updating in “Update air control surface position” block 21 and general housekeeping in “Perform housekeeping” block 24 is performed in a continuous execution loop.

Loop execution monitoring for changes in aerodynamic input sensor values 25 is performed by “Sensor values changed” block 17 to determine if any significant environmental changes have occurred. If no changes are detected execution continues with the “Update air control surface position” block 21. If new sensor values 17 are detected, program execution is transferred to the algorithms used to filter and normalize the sensor values and calculate calibration bias offsets 18. If the sensor values that have been filtered and normalized indicate that a significant environmental change has occurred in the “Environment conditions changed” block 19 program execution continues with the “Compute new aerodynamic model” block 20 and the update air control surfaces flag is set and program execution continues with the “Updated Air control surface position” block 21.

With continued reference to FIG. 2 and additional reference to FIG. 3, when any sensor values have changed beyond the minimum threshold limits then new aerodynamic model computations are performed “Compute new aerodynamic model” block 20 and the results are then used by the servo positioning control algorithms in the “Compute new airfoil values, positions and motion velocity” block 22. Each of the vehicle's air control surface models are designed to obtain the minimum drag coefficient based on the vehicle's aerodynamic profile and the current environmental conditions as detected by the sensors 25. Each time a new air control surface model is calculated the “Update air control surface position” block 21 is set to true to indicate that new air control surface positions are to be calculated.

From these continuous computations, new air foil positions and motion velocities are calculated using common Proportional Integral and Derivative (PID) gain control feed-back loop algorithms in the “Compute new airfoil values, positions and motion velocity” block 22, which continuously fine tunes the rate and position of each airfoil control surface by sending the newly computed positioning commands to the Motion Control Processor 34 for adjusting the vehicle's movable aerodynamic surfaces.

With continued reference to FIG. 2, with each iteration through the loop (17 through 24) additional housekeeping functions are performed in “Perform housekeeping” block 24. These include management of watchdog timers used to detect microprocessor or software failures and monitoring of vehicle operational characteristics to verify proper operation of each movable aerodynamic surfaces and aerodynamic input sensors.

IV. Servo Controller System

With continued reference to FIG. 3 and additional reference to FIG. 1, the attached linear servo positioning motors 3, 6, 8 as depicted in FIG. 1 and, 37 in FIG. 3 and circuits 34-40 will be described. Each of the vehicle's movable aerodynamic surfaces 2, 7, and 5 and 38 in FIG. 2) are continually positioned using digitally controlled servo positioning motors (3, 6, and 8 in FIG. 1 and 37 in FIG. 3). There is one servo control circuit 34-40 and servo motor 37 for each of the vehicle's movable aerodynamic surfaces 38. These digitally controlled servo positioning motors 37 and control circuits 34-40 provide movable aerodynamic surface control over a range of motion as needed for a specific vehicle. While it is important to the present invention to directly control the position of a vehicle's movable aerodynamic surfaces, the exact hardware linkage and methods of air surface control motion are already well known in the art and will differ for every vehicle.

The active Aerodynamic Control Unit 4 implements a separate Motion Control Processor 34 and dedicated closed-loop digital servo controller circuits 41 for each dynamically controlled movable air surface 2, 5, 7 as shown in FIG. 1, which perform the servo compensation algorithms as well as trajectory profiles (trapezoidal) functions. These dedicated microcontrollers and circuits continuously compute each air surface control servo motor's compensation functions which allow for both fine positioning control as well as rapid motion when needed in response to sudden aerodynamic or other vehicle environment changes. These compensation algorithms are necessary for optimal air surface control motion and are implemented using common closed-loop gain algorithms. These types of closed-loop digital servo controller circuits and algorithms are well known in the art and are commonly used in many digital motion control applications.

The present invention implements a closed-loop digital servo control circuit 41 for each dynamically controlled movable air surface 2, 5, 7 as shown in FIG. 1. Each closed-loop servo controller circuit provides the exact digital positioning of each of the vehicle's movable aerodynamic surfaces as determined by the aerodynamic computational math functions. The embedded Aerodynamic Control Unit's 4 aerodynamic math functions provide commands and target positions that are then converted to motion control profiles for each of the vehicle's movable aerodynamic surfaces 2, 5, 7.

Referring to FIG. 3 the system controls each of the movable aerodynamic surfaces with a servo positioning motor 37 connected to an incremental feedback encoder 39 also known as a sequential encoder. The incremental feedback encoder 39 produces quadrature pulses to the position feedback encoder 40 from which accurate position, speed, and direction of the servo positioning motor 37 can be derived. When combined with the D/A (Digital-to-Analog) 35 converter, and a power amplifier 36, which delivers current or voltage to the servo positioning motors 37, a closed-loop system for digitally controlling the position of each of the vehicle's moveable aerodynamic surfaces can be described.

As described above the motion control processor 34 acts as the brain of the of the system by taking the desired target positions and motion profiles from the main microprocessor 32 and creates the trajectories and rates for the servo positioning motors 37 to follow, by outputting digital values to the D/A digital converter 35, which in turn provides low-level analog signals to the servo driver power amplifier circuits 36. The servo driver power amplifier circuits 36 amplify the low-level analog outputs from the D/A digital converter 35 and generate the proper current and polarity required to drive or turn the servo positioning motors 37 used to position each of the vehicle's moveable aerodynamic surfaces 2, 5, 7.

The servo positioning motors 37 turn the electrical energy from the servo driver power amplifier circuits 36 into mechanical energy and produce the torque required to move the vehicle's moveable aerodynamic surfaces 2, 7, 5 to the desired target positions. The moyable aerodynamic surfaces 2, 5, 7 are mechanical elements that are designed to provide a range of aerodynamic control using the servo positioning motors 37 along with mechanical linkage 38 that convert torque to linear motion. The mechanical linkage 38 can include linear slides, cam arms, and special actuators. These types of motion control mechanics, mechanical linkage 38 and movable aerodynamic surfaces are well known in the art.

The incremental feedback encoder 39 (usually a quadrature encoder) is connected to a position feedback encoder 40 to provide feedback or positioning information which senses the servo positioning motors 37 positions and reports the result to the motion controller 34, thereby closing the loop to the motion controller 34 so each moveable aerodynamic surface 2, 5, 7 is under constant positional control by the microprocessor 32.

V. Moveable Aerodynamic Surfaces

A summary of the moveable aerodynamic surfaces 2, 7, 5 will be described with continued reference to FIG. 1 and FIG. 3. Specific detailed descriptions for each will be described further in the following sections. In the present preferred embodiment, moveable aerodynamic surfaces are used to affect the overall aerodynamic efficiency of the motor vehicle. Each moveable aerodynamic surface is operatively moved or positioned between a first or aerodynamically neutral position and a range of second or higher angle of deflection or aerodynamically active positions. Each of the moveable aerodynamic surfaces is positioned by a linear servo positioning motor 37 or other motion control device. In general and as one example of the preferred embodiment, 3, 6, and 8 in FIG. 1 and 37 in FIG. 3 shows each servo positioning motor as wired to the Aerodynamic Control Unit 4 and provides electrical signals that control the required angle or position of each moveable aerodynamic surface as determined by the Aerodynamic Control Unit's 4 microprocessor 32 and software algorithms for the purposes of improving the over all aerodynamic drag and efficiencies of the motor vehicle under varying vehicle and wind speeds as well as relative wind direction and road surface conditions.

a. Active Front Air Dam

With continued reference to FIG. 1 and FIG. 3 the active front air dam assembly 2 of the present invention will now be described. The active air dam is made of metal or plastic fitted to or integrated with the front bumper or fascia of a motor vehicle and is intended to enhance aerodynamics and stability by varying the blocking of the turbulent air flow under the vehicle chassis. The active front air dam assembly is intended to include a movable portion or aerodynamic surface member mounted to an articulating assembly attached to or integrated with the front underside bumper or fascia of the motor vehicle. The active air dam is operative for movement between a first aerodynamic neutral or retracted position and a range of secondary aerodynamically active or deployed positions. The movable main body of the air dam is adapted to translate downwardly from behind the front bumper or fascia surface of the vehicle to various depths as determined by the attached servo motor 37 attached to the main movable airfoil body. The range of motion is determined as described elsewhere in this patent.

b. Active Rear Airfoil Spoiler

With continued reference to FIG. 1 and FIG. 3 the active rear spoiler assembly 5 of the present invention will be described. The active rear spoiler is made of metal or plastic fitted to the rear deck lid or roof of a motor vehicle and is intended to enhance aerodynamics and stability by varying the direction of air flow as it leaves the rear of the vehicle. The active rear spoiler assembly 5 is intended to include a main airfoil portion or aerodynamic surface member mounted to an articulating assembly attached to and on the underside of the rear deck lid or roof of the vehicle and is operative for movement in a range between positive and negative angles of indices as determined by an attached servo positioning motor 37 attached to the main movable airfoil body. In another consideration the rear portion of the airfoil movable body is adapted to extend upwardly from the surface of the rear deck lid or roof at various angles as determined by the servo positioning motor 37. The range of motion is determined as described elsewhere in this patent.

c. Active Rocker Panels

With continued reference to FIG. 1 and FIG. 3 the active rocker panel assemblies 7 of the present invention will now be described. The active rocker panels are made of metal or plastic fitted on or integrated with each side of the vehicle and beneath the vehicle's side skirts between the front and rear wheels and is intended to enhance aerodynamics and stability by varying the blocking of the side turbulent air flow from entering under the chassis. The active rocker panel assembly 7 is intended to include a movable portion or aerodynamic surface member mounted to an articulating assembly attached beneath the side skirts of the motor vehicle. The active rocker panels 7 are operative for movement between a first aerodynamic neutral or retracted position and a range of secondary aerodynamically active or deployed positions. The movable bodies of the rocker panels 7 are adapted to extend downwardly from under the vehicle's side skirts too various depths as determined by the attached servo positioning motor 37 attached to said active rocker panels 7. The range of motion is determined as described elsewhere in this patent.

The foregoing description details certain preferred embodiments of the present invention and describes the best mode contemplated. It will be appreciated, however, that no matter how detailed the foregoing description appears, the invention can be practiced in many ways without departing from the spirit of the invention. Therefore, the description contained in this specification is to be considered exemplary, rather than limiting, and the true scope of the invention is only limited by the following claims and any equivalents thereof.

What is claimed is:

1. A device for monitoring and dynamically adjusting an active, real-time, aerodynamic system for a motor vehicle, thereby improving fuel efficiency and stability, comprising:
a. an active aerodynamic control unit with aerodynamic control algorithms;
b. vehicle performance and environment input system;
c. a plurality of moveable, active aerodynamic surfaces; and
d. a servo controller system for variable position control of said aerodynamic surfaces.

2. A device for monitoring and dynamically adjusting an active, real-time, aerodynamic system for a motor vehicle, thereby improving fuel efficiency and stability, comprising:
a. vehicle performance and environment input system for receiving performance and environmental signals and for generating appropriate analog signals as output;
b. a plurality of moveable, active aerodynamic surfaces capable of movement over a range of motion;
c. a servo controller system, coupled to said aerodynamic surfaces, comprising a plurality of servo control circuits that drive each of said active aerodynamic surfaces over a range of motion;
d. an active aerodynamic control unit with aerodynamic control algorithms, accepting input from said vehicle performance and environment input system, executing a plurality of aerodynamic control algorithms which collectively determine the best position for each of said moveable active aerodynamic surfaces of the vehicle through the direct control of said servo controller system.

3. The vehicle performance and environment input system of claim 2 further comprising:
a. a proximity sensor to detect approaching objects and/or extreme irregularities in the traveling surface;
b. a air temperature sensor;
c. a vehicle ground speed sensor;
d. a vehicle air speed sensor;
e. a plurality of air pressure sensors;
f. wherein analog output from the sensors are used as input signals to an aerodynamic control unit.

4. A plurality of moveable, active aerodynamic surfaces of claim 2 further comprising:
a. an active air dam made of durable weather-resistant material fitted to or integrated with the front bumper or fascia of a vehicle to enhance aerodynamics and stability by varying the blocking of the turbulent air flow under the vehicle chassis whereby the active front air dam assembly includes a movable aerodynamic surface member mounted to an articulating assembly attached to or integrated with the front underside bumper or fascia of the motor vehicle and the active air dam is operative for movement between a first aerodynamic neutral or retracted position and a range of secondary aerodynamically active or deployed positions, wherein the movable main body of the air dam is adapted to translate downwardly from behind the front bumper or fascia surface of the vehicle to various depths as determined ultimately by the aerodynamic control unit and servo controllers;
b. an active rear spoiler assembly made from durable, weather-resistant material, including a main airfoil portion mounted to an articulating assembly attached to the underside of the rear deck lid or roof and is movable in a continuous range between positive and negative angles of indices as determined ultimately by the aerodynamic control unit and servo controllers;
c. an active rocker panels made from durable, weather-resistant material and fitted on or integrated with each side of the vehicle and beneath the vehicle's side skirts between the front and rear wheels and enhances aerodynamics and stability by varying the blocking of the side turbulent air flow from entering under the chassis whereby the active rocker panel assembly includes a movable portion or aerodynamic surface member mounted to an articulating assembly attached beneath the side skirts of the motor vehicle and the active rocker panels are operative for movement between a first aerodynamic neutral or retracted position and a range of secondary aerodynamically active or deployed positions, wherein the movable bodies of the rocker panels are adapted to extend downwardly from under the vehicle's side skirts too various depths as determined ultimately by the aerodynamic control unit and servo controller system.

5. A servo controller system of claim 2 further comprising:
a. a plurality of closed-loop digital servo controller circuits for each moveable, active aerodynamic surfaces;
b. a plurality of motion control processors capable of performing servo compensation algorithms and trajectory profiles, said motion control processors coupled to each of said servo controller circuits;

6. An aerodynamic control unit of claim 2 further comprising:
a. a plurality of integrated analog to digital signal conversion circuits used to accept input from the vehicle performance and environment input system;
b. a programmable microprocessor programmed with aerodynamic control algorithms to calculate aerodynamic efficiency based on the vehicle performance and environment input system.

7. A programmable microprocessor of claim 6 further comprising:
a. the power system of the vehicle providing power to the microprocessor;
b. a non-volatile storage media coupled to said microprocessor wherein the embedded aerodynamic control algorithms are stored within said non-volatile storage media;
c. the microprocessor being connected to a vehicle performance and environment input system;
d. the microprocessor further being connected to a plurality of servo controller systems;
e. wherein the microprocessor performs software computations and through continuous input from the vehicle performance and environment input system continuously maintains and positions the moveable, active aerodynamic surfaces.

8. A method for monitoring and dynamically adjusting a device of claim 2 comprising:
a. measuring the performance and environmental factors affecting drag by use of a vehicle performance and environment input system;
b. performing aerodynamic control algorithms in an aerodynamic control unit;
c. the output of the aerodynamic control unit driving a plurality of servo controller systems;
d. said servo controller system in turn driving a plurality of moveable aerodynamic air surfaces and providing feedback data to said servo controller system;
e. said servo controller system in turn providing feedback data to said aerodynamic control unit.

9. A method of performing aerodynamic control algorithms in an aerodynamic control unit of claim 8 further comprising:
a. aerodynamic control algorithms loading from non-volatile program memory into the microprocessor's execution memory;
b. performing several setup and initialization functions;
c. waiting for commands from the servo controller system indicating that the servo controller system is available for accepting position commands;
d. loop execution monitoring being performed by constantly evaluating whether the performance and environmental sensors have changed;
e. computing new aerodynamic model based on performance and environmental sensors;
f. updating a software flag to determine whether to change the aerodynamic air surface positions;
g. computing new aerodynamic air surface positions;
h. transferring new positioning data to a servo controller system;
i. wherein all functions are performed in a continuous execution loop.

10. A method for dynamically controlling the moveable aerodynamic surfaces by way of the servo controller system of claim 5 further comprising:
a. a motion controller processor sending and receiving digital positioning commands to an aerodynamic control unit;
b. said motion controller processor being coupled to digital to analog converters;
c. said digital to analog converters being coupled to a power amplifier;
d. said power amplifier being coupled to a servo positioning motor;
e. said servo positioning motor being capable of driving the moveable aerodynamic air surfaces, and said servo positioning motor having an additional output which outputs data relating to the position of said moveable aerodynamic air surfaces;
f. wherein an incremental feedback encoder circuits accepts the output data from said servo positioning motor position encoders;
g. wherein an position feedback encoder circuit accepts the output from said incremental feedback encoder and reports the result to said motion controller processor.
